(19) United States
(12) Patent Application Publication
(10) Pub. No.: US 2026/0199907 A1
(43) Pub. Date: Jul. 16, 2026

(54) METHOD FOR FLOTATION OF ARGILLACEOUS ZINC OXIDE ORE WITH FULL-SIZE FRACTIONS

(71) Applicant: Kunming University of Science and Technology, Kunming City (CN)

(72) Inventors: Qicheng FENG, Kunming City (CN); Yanyu TANG, Kunming City (CN); Wenjuan ZHAO, Kunming City (CN); Shuming WEN, Kunming City (CN); Runpeng LIAO, Kunming City (CN); Song ZHANG, Kunming City (CN)

(21) Appl. No.: 19/436,427

(22) Filed: Dec. 30, 2025

(30) Foreign Application Priority Data
Jan. 10, 2025 (CN) 202510044130.3

(51) Int. Cl. B03D 1/002; B03B 9/00

(52) U.S. Cl. CPC B03D 1/002; B03B 9/00; B03D 2201/02; B03D 2203/04

(57) ABSTRACT

A method for flotation of argillaceous zinc oxide ore with full-size fractions includes: mixing the argillaceous zinc oxide ore with a compound regulator, then grinding, and adding water and conditioning; adding sodium sulfide, a compound inhibitor and a compound collector sequentially to a resulting argillaceous zinc oxide pulp, and conducting a primary rougher; adding sodium sulfide, the compound inhibitor and the compound collector sequentially to an obtained primary rougher tailings, and conducting a secondary rougher; adding the compound inhibitor and the compound collector sequentially to an obtained secondary rougher tailings, and conducting a scavenger; and combining a resulting primary rougher concentrate and a resulting secondary rougher concentrate, and conducting a cleaner, where an obtained cleaner tailings and a resulting scavenger concentrate are combined, conditioned and returned to the secondary rougher.

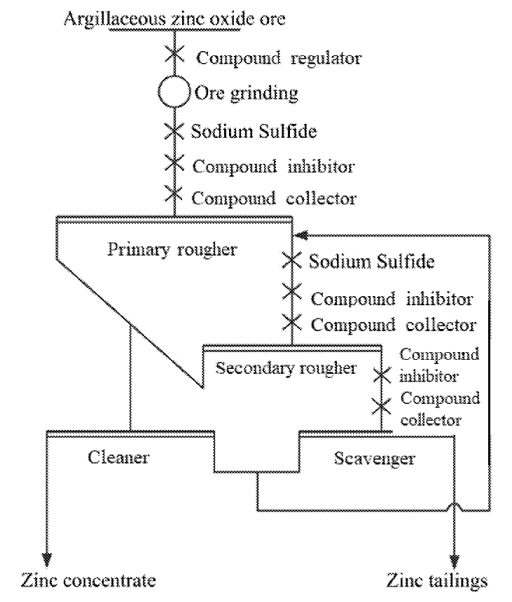

### CROSS REFERENCE TO RELATED APPLICATION

This patent application claims priority to Chinese Patent Application No. 202510044130.3 filed with the China National Intellectual Property Administration on January 10, 2025, the disclosure of which is incorporated by reference herein in its entirety as part of the present application.

### TECHNICAL FIELD

The present disclosure relates to a method for flotation of argillaceous zinc oxide ore with full-size fractions, belonging to the technical field of mineral processing.

### BACKGROUND

Zinc is widely used in various fields, such as corrosion protection, battery manufacturing, electrical equipment, precision casting, and defense industries. Zinc oxide minerals are an important source for extracting zinc metal. However, conventional beneficiation methods struggle to recover them efficiently, owing to the strong hydrophilicity of zinc oxide mineral surfaces, high content of soluble salts in ores, complex intergrowth with gangue minerals, a large amount of primary slimes in zinc oxide ore, and the generation of secondary slimes during the processes such as mining, transportation, crushing, and grinding.

Sulfidization-amine flotation is an effective method for separating and enriching zinc oxide minerals. However, amine collectors are extremely sensitive to slimes. This is because slimes consume a large amount of positively charged amine collectors and also adhere to the surface of various minerals, so that the collectors cannot be selectively interacted with zinc oxide minerals. Moreover, these amine-coated slimes also adhere to mineralized froths, such that flotation froths are jointly “armored” by the slimes and amine collectors. This results in a long lifespan and high stability of the flotation froths, which not only increases the circulation volume of middlings but also severely impairs the mobility of ore-loaded froths, making froth collapse difficult. As a result, severe “froth overflow” occurs. Ultimately, it is difficult to control the flotation process and carry out the production. Although desliming can achieve better flotation indices, the removed slimes contain a large amount of fine-grained zinc oxide minerals, which cannot be effectively recovered by existing processes and technologies, resulting in significant zinc metal loss. This greatly limits the large-scale application of sulfidization-amine flotation in zinc oxide beneficiation plants.

Therefore, there is an urgent need to develop a method for flotation of argillaceous zinc oxide ore with full-size fractions, thereby allowing for the economical and efficient flotation and recovery of zinc oxide ore resources without desliming.

### SUMMARY OF THE DISCLOSURE

To address the problems of severe zinc mineral loss in the desliming flotation process as well as a high circulation volume of middlings and poor beneficiation indices in non-desliming flotation for argillaceous zinc oxide ore, the present disclosure provides a method for flotation of argillaceous zinc oxide ore with full-size fractions. Starting from the concept of integrated regulation covering the entire process of ore grinding, conditioning, and collecting, novel flotation reagents are developed to selectively regulate mineral surface characteristics and the pulp solution environment, thereby enabling the efficient flotation of zinc oxide minerals of different particle sizes in argillaceous zinc oxide ore without desliming.

A method for flotation of argillaceous zinc oxide ore with full-size fractions includes:

(1) mixing the argillaceous zinc oxide ore with a compound regulator uniformly, then grinding until zinc oxide mineral is liberated, and adding water and conditioning until a mass percentage concentration of a resulting pulp reaches to 24% to 38%, to obtain an argillaceous zinc oxide pulp;

(2) adding sodium sulfide, a compound inhibitor and a compound collector sequentially to the argillaceous zinc oxide pulp obtained in step (1), and conducting a primary rougher to obtain a primary rougher concentrate and primary rougher tailings;

(3) adding sodium sulfide, the compound inhibitor and the compound collector sequentially to the primary rougher tailings obtained in step (2), and conducting a secondary rougher to obtain a secondary rougher concentrate and secondary rougher tailings;

(4) adding the compound inhibitor and the compound collector sequentially to the secondary rougher tailings obtained in step (3), and conducting a scavenger to obtain a scavenger concentrate and flotation zinc tailings; and

(5) combining the primary rougher concentrate obtained in step (2) and the secondary rougher concentrate obtained in step (3), and conducting a cleaner to obtain a flotation zinc concentrate and cleaner tailings, where the cleaner tailings and the scavenger concentrate obtained in step (4) are combined, conditioned and returned to the secondary rougher;

where the compound regulator is a mixture of triethanolamine, triisopropanolamine and dodecylbenzene; the compound inhibitor is a mixture of sodium silicate, aminotrimethylene phosphonic acid and a phosphonocarboxylic acid copolymer; and the compound collector is a mixture of aminododecane acetate, dioctyl sodium sulfosuccinate and peregal O-25 (fatty alcohol polyoxyethylene ether (25 EO)).

In some embodiments, a mass percentage content of zinc in the argillaceous zinc oxide ore of step (1) is in a range of 4.2% to 8.6%.

In some embodiments, in terms of each ton of the argillaceous zinc oxide ore, the compound regulator is added in step (1) in an amount of 300 g to 700 g.

In some embodiments, in terms of each ton of the argillaceous zinc oxide ore, 6 kg to 10 kg of sodium sulfide, 1600 g to 2400 g of the compound inhibitor and 280 g to 440 g of the compound collector are added for conducting the primary rougher in step (2).

In some embodiments, in terms of each ton of the argillaceous zinc oxide ore, 1.5 kg to 2.5 kg of sodium sulfide, 400 g to 600 g of the compound inhibitor and 70 g to 110 g of the compound collector are added for conducting the secondary rougher in step (3).

In some embodiments, in terms of each ton of the argillaceous zinc oxide ore, 200 g to 300 g of the compound inhibitor and 35 g to 55 g of the compound collector are added for conducting the scavenger in step (4).

In some embodiments, taking a mass fraction of the compound regulator as 100%, the triethanolamine accounts for 45% to 65%, the triisopropanolamine accounts for 25% to 35%, and the dodecylbenzene accounts for 10% to 20%.

In some embodiments, taking a mass fraction of the compound inhibitor as 100%, the sodium silicate accounts for 55% to 75%, the aminotrimethylene phosphonic acid accounts for 15% to 25%, and the phosphonocarboxylic acid copolymer accounts for 10% to 20%.

In some embodiments, taking a mass fraction of the compound collector as 100%, the aminododecane acetate accounts for 40% to 60%, the dioctyl sodium sulfosuccinate accounts for 30% to 40%, and the peregal O-25 accounts for 10% to 20%.

Some embodiments of the present disclosure have the following beneficial effects:

(1) Starting from the concept of integrated regulation encompassing the entire process of ore grinding, conditioning, and collecting, the present disclosure selectively regulates mineral surface characteristics and the pulp solution environment by developing a novel flotation reagent, economically and effectively solves the problems of severe zinc mineral loss in the desliming flotation process as well as a high circulation volume of middlings and poor beneficiation indices in non-desliming flotation for argillaceous zinc oxide ore, and achieves the flotation recovery of argillaceous zinc oxide ore with full-size fractions.

(2) The present disclosure regulates the surface energy based on the interaction between polar groups of a compound regulator and the surface of ore particles, which not only reduces the surface hardness and compressive strength of zinc oxide ore particles but also weakens the agglomeration between ore particles and their adhesion to mill liners and ore grinding media, thereby effectively improving the grinding performance, dispersion behavior and particle grading composition of the ore, and establishing prerequisites for the flotation of argillaceous zinc oxide ore with full-size fractions.

(3) The combined use of a compound inhibitor and a compound collector of the present disclosure not only selectively enhances the hydrophobicity of the zinc oxide mineral surface, and increases the floatability difference between zinc oxide minerals and gangue minerals, but also optimizes the flotation froth structure and the mineral-carrying capacity. It solves the problems of froth control and slime depression in the flotation process of argillaceous zinc oxide ore, creating a new pathway for the efficient separation and enrichment of complex and refractory zinc oxide ore.

### BRIEF DESCRIPTION OF THE DRAWING

The Figure shows a flow diagram of the process according to an embodiment of the present disclosure.

### DETAILED DESCRIPTION OF THE EMBODIMENTS

The present disclosure will be further described in detail below with reference to specific embodiments, but the scope of the present disclosure is not limited to these contents.

In the following examples of the present disclosure, the compound regulator was a mixture of triethanolamine, triisopropanolamine and dodecylbenzene; the compound inhibitor was a mixture of sodium silicate, aminotrimethylene phosphonic acid and a phosphonocarboxylic acid copolymer; and the compound collector was a mixture of aminododecane acetate, dioctyl sodium sulfosuccinate and peregal O-25.

### Example 1

In this example, taking a mass fraction of the compound regulator as 100%, the triethanolamine accounted for 45%, the triisopropanolamine accounted for 35%, and the dodecylbenzene accounted for 20%; taking a mass fraction of the compound inhibitor as 100%, the sodium silicate accounted for 55%, the aminotrimethylene phosphonic acid accounted for 25%, and the phosphonocarboxylic acid copolymer accounted for 20%; and taking a mass fraction of the compound collector as 100%, the aminododecane acetate accounted for 40%, the dioctyl sodium sulfosuccinate accounted for 40%, and the peregal O-25 accounted for 20%.

As shown in the figure, a method for flotation of argillaceous zinc oxide ore with full-size fractions was carried out by the following steps:

(1) the argillaceous zinc oxide ore was mixed with a compound regulator uniformly, a resulting mixture was then added into a ball mill and ground until zinc oxide mineral was liberated, and water was added and conditioning was conducted until a mass percentage concentration of an obtained pulp was 24%, to obtain an argillaceous zinc oxide pulp; in terms of each ton of the argillaceous zinc oxide ore, 300 g of the compound regulator was added to the ball mill; where a mass percentage content of zinc in the argillaceous zinc oxide ore was 4.2%;

(2) sodium sulfide, a compound inhibitor and a compound collector were added sequentially to the argillaceous zinc oxide pulp obtained in step (1), and a primary rougher was conducted to obtain a primary rougher concentrate and primary rougher tailings; in terms of each ton of the argillaceous zinc oxide ore, 6 kg of sodium sulfide, 1600 g of the compound inhibitor and 280 g of the compound collector were added for conducting the primary rougher;

(3) sodium sulfide, the compound inhibitor and the compound collector were added sequentially to the primary rougher tailings obtained in step (2), and a secondary rougher was conducted to obtain a secondary rougher concentrate and secondary rougher tailings; in terms of each ton of the argillaceous zinc oxide ore, 1.5 kg of sodium sulfide, 400 g of the compound inhibitor and 70 g of the compound collector were added for conducting the secondary rougher;

(4) the compound inhibitor and the compound collector were added sequentially to the secondary rougher tailings obtained in step (3), and a scavenger was conducted to obtain a scavenger concentrate and flotation zinc tailings; in terms of each ton of the argillaceous zinc oxide ore, 200 g of the compound inhibitor and 35 g of the compound collector were added for conducting the scavenger; and

(5) the primary rougher concentrate obtained in step (2) and the secondary rougher concentrate obtained in step (3) were combined, and a cleaner was conducted to obtain a flotation zinc concentrate and cleaner tailings, where the cleaner tailings and the scavenger concentrate obtained in step (4) were combined, conditioned and returned to the secondary rougher.

In this example, the flotation recovery of zinc was 82.8%.

### Example 2

In this example, taking a mass fraction of the compound regulator as 100%, the triethanolamine accounted for 55%, the triisopropanolamine accounted for 30%, and the dodecylbenzene accounted for 15%; taking a mass fraction of the compound inhibitor as 100%, the sodium silicate accounted for 65%, the aminotrimethylene phosphonic acid accounted for 20%, and the phosphonocarboxylic acid copolymer accounted for 15%; and taking a mass fraction of the compound collector as 100%, the aminododecane acetate accounted for 50%, the dioctyl sodium sulfosuccinate accounted for 35%, and the peregal O-25 accounted for 15%.

As shown in the Figure, a method for flotation of an argillaceous zinc oxide ore with full-size fractions was carried out by the following steps:

(1) the argillaceous zinc oxide ore was mixed with a compound regulator uniformly, a resulting mixture was then added into a ball mill and ground until zinc oxide mineral was liberated, and water was added and conditioning was conducted until a mass percentage concentration of an obtained pulp reaches 31%, to obtain an argillaceous zinc oxide pulp; in terms of each ton of the argillaceous zinc oxide ore, 500 g of the compound regulator was added to the ball mill; where a mass percentage content of zinc in the argillaceous zinc oxide ore was 6.4%;

(2) sodium sulfide, a compound inhibitor and a compound collector were added sequentially to the argillaceous zinc oxide pulp obtained in step (1), and a primary rougher was conducted to obtain a primary rougher concentrate and primary rougher tailings; in terms of each ton of the argillaceous zinc oxide ore, 8 kg of sodium sulfide, 2000 g of the compound inhibitor and 360 g of the compound collector were added for conducting the primary rougher;

(3) sodium sulfide, the compound inhibitor and the compound collector were added sequentially to the primary rougher tailings obtained in step (2), and a secondary rougher was conducted to obtain a secondary rougher concentrate and secondary rougher tailings; in terms of each ton of the argillaceous zinc oxide ore, 2.0 kg of sodium sulfide, 500 g of the compound inhibitor and 90 g of the compound collector were added for conducting the secondary rougher;

(4) the compound inhibitor and the compound collector were added sequentially to the secondary rougher tailings obtained in step (3), and a scavenger was conducted to obtain a scavenger concentrate and flotation zinc tailings; in terms of each ton of the argillaceous zinc oxide ore, 250 g of the compound inhibitor and 45 g of the compound collector were added for conducting the scavenger; and

(5) the primary rougher concentrate obtained in step (2) and the secondary rougher concentrate obtained in step (3) were combined, and a cleaner was conducted to obtain a flotation zinc concentrate and cleaner tailings, where the cleaner tailings and the scavenger concentrate obtained in step (4) were combined, conditioned and returned to the secondary rougher.

In this example, the flotation recovery of zinc was 84.5%.

### Example 3

In this example, taking a mass fraction of the compound regulator as 100%, the triethanolamine accounted for 65%, the triisopropanolamine accounted for 25%, and the dodecylbenzene accounted for 10%; taking a mass fraction of the compound inhibitor as 100%, the sodium silicate accounted for 75%, the aminotrimethylene phosphonic acid accounted for 15%, and the phosphonocarboxylic acid copolymer accounted for 10%; and taking a mass fraction of the compound collector as 100%, the aminododecane acetate accounted for 60%, the dioctyl sodium sulfosuccinate accounted for 30%, and the peregal O-25 accounted for 10%.

As shown in the figure, a method for flotation of argillaceous zinc oxide ore with full-size fractions was carried out by the following steps:

(1) the argillaceous zinc oxide ore was mixed with a compound regulator uniformly, a resulting mixture was then added into a ball mill and ground until zinc oxide mineral was liberated, and water was added and conditioning was conducted until a mass percentage concentration of an obtained pulp reaches to 38%, to obtain an argillaceous zinc oxide pulp; in terms of each ton of the argillaceous zinc oxide ore, 700 g of the compound regulator was added to the ball mill; where a mass percentage content of zinc in the argillaceous zinc oxide ore was 8.6%;

(2) sodium sulfide, a compound inhibitor and a compound collector were added sequentially to the argillaceous zinc oxide pulp obtained in step (1), and a primary rougher was conducted to obtain a primary rougher concentrate and primary rougher tailings; in terms of each ton of the argillaceous zinc oxide ore, 10 kg of sodium sulfide, 2400 g of the compound inhibitor and 440 g of the compound collector were added for conducting the primary rougher;

(3) sodium sulfide, the compound inhibitor and the compound collector were added sequentially to the primary rougher tailings obtained in step (2), and a secondary rougher was conducted to obtain a secondary rougher concentrate and secondary rougher tailings; in terms of each ton of the argillaceous zinc oxide ore, 2.5 kg of sodium sulfide, 600 g of the compound inhibitor and 110 g of the compound collector were added for conducting the secondary rougher;

(4) the compound inhibitor and the compound collector were added sequentially to the secondary rougher tailings obtained in step (3), and a scavenger was conducted to obtain a scavenger concentrate and flotation zinc tailings; in terms of each ton of the argillaceous zinc oxide ore, 300 g of the compound inhibitor and 55 g of the compound collector were added for conducting the scavenger; and

(5) the primary rougher concentrate obtained in step (2) and the secondary rougher concentrate obtained in step (3) were combined, and a cleaner was conducted to obtain a flotation zinc concentrate and cleaner tailings, where the cleaner tailings and the scavenger concentrate obtained in step (4) were combined, conditioned and returned to the secondary rougher.

In this example, the flotation recovery of zinc was 86.3%.

The specific embodiments of the present disclosure have been described in detail above. However, the present disclosure is not limited to the above embodiments. Within the scope of knowledge possessed by those skilled in the art, various alterations can be made without departing from the spirit of the present disclosure.

What is claimed:

1. A method for flotation of argillaceous zinc oxide ore with full-size fractions, comprising:
(1) mixing the argillaceous zinc oxide ore with a compound regulator uniformly, then grinding until zinc oxide mineral is liberated, and adding water and conditioning until a mass percentage concentration of a resulting pulp reaches 24% to 38%, to obtain an argillaceous zinc oxide pulp;
(2) adding sodium sulfide, a compound inhibitor and a compound collector sequentially to the argillaceous zinc oxide pulp obtained in step (1), and conducting a primary rougher to obtain a primary rougher concentrate and primary rougher tailings;
(3) adding sodium sulfide, the compound inhibitor and the compound collector sequentially to the primary rougher tailings obtained in step (2), and conducting a secondary rougher to obtain a secondary rougher concentrate and secondary rougher tailings;
(4) adding the compound inhibitor and the compound collector sequentially to the secondary rougher tailings obtained in step (3), and conducting a scavenger to obtain a scavenger concentrate and flotation zinc tailings; and
(5) combining the primary rougher concentrate obtained in step (2) and the secondary rougher concentrate obtained in step (3), and conducting a cleaner to obtain a flotation zinc concentrate and cleaner tailings, wherein the cleaner tailings and the scavenger concentrate obtained in step (4) are combined, conditioned and returned to the secondary rougher;
wherein the compound regulator is a mixture of triethanolamine, triisopropanolamine and dodecylbenzene; the compound inhibitor is a mixture of sodium silicate, aminotrimethylene phosphonic acid and a phosphonocarboxylic acid copolymer; and the compound collector is a mixture of aminododecane acetate, dioctyl sodium sulfosuccinate and peregal O-25.

2. The method for flotation of the argillaceous zinc oxide ore with full-size fractions of claim 1, wherein in step (1), a mass percentage content of zinc in the argillaceous zinc oxide ore is in a range of 4.2% to 8.6%.

3. The method for flotation of the argillaceous zinc oxide ore with full-size fractions of claim 1, wherein in step (1), in terms of each ton of the argillaceous zinc oxide ore, the compound regulator is added in an amount of 300 g to 700 g.

4. The method for flotation of the argillaceous zinc oxide ore with full-size fractions of claim 1, wherein in terms of each ton of the argillaceous zinc oxide ore, 6 kg to 10 kg of sodium sulfide, 1600 g to 2400 g of the compound inhibitor and 280 g to 440 g of the compound collector are added for conducting the primary rougher in step (2).

5. The method for flotation of the argillaceous zinc oxide ore with full-size fractions of claim 1, wherein in terms of each ton of the argillaceous zinc oxide ore, 1.5 kg to 2.5 kg of sodium sulfide, 400 g to 600 g of the compound inhibitor and 70 g to 110 g of the compound collector are added for conducting the secondary rougher in step (3).

6. The method for flotation of the argillaceous zinc oxide ore with full-size fractions of claim 1, wherein in terms of each ton of the argillaceous zinc oxide ore, 200 g to 300 g of the compound inhibitor and 35 g to 55 g of the compound collector are added for conducting the scavenger in step (4).

7. The method for flotation of the argillaceous zinc oxide ore with full-size fractions of claim 1, wherein taking a mass fraction of the compound regulator as 100%, the triethanolamine accounts for 45% to 65%, the triisopropanolamine accounts for 25% to 35%, and the dodecylbenzene accounts for 10% to 20%.

8. The method for flotation of the argillaceous zinc oxide ore with full-size fractions of claim 1, wherein taking a mass fraction of the compound inhibitor as 100%, the sodium silicate accounts for 55% to 75%, the aminotrimethylene phosphonic acid accounts for 15% to 25%, and the phosphonocarboxylic acid copolymer accounts for 10% to 20%.

9. The method for flotation of the argillaceous zinc oxide ore with full-size fractions of claim 1, wherein taking a mass fraction of the compound collector as 100%, the aminododecane acetate accounts for 40% to 60%, the dioctyl sodium sulfosuccinate accounts for 30% to 40%, and the peregal O-25 accounts for 10% to 20%.
